(19) United States
(12) Patent Application Publication
(10) Pub. No.: US 2020/0349798 A1
(43) Pub. Date: Nov. 5, 2020

(54) INTERACTIVE SLOT MACHINE ARCHITECTURE WITH LIMITED BONUS ROUND ENTRY

(71) Applicant: Press Play Inc., Dallas, TX (US)

(72) Inventor: Benjamin Liss, Dallas, TX (US)

(73) Assignee: Press Play Inc., Dallas, TX (US)

(21) Appl. No.: 16/848,827

(22) Filed: Apr. 14, 2020

Related U.S. Application Data
(63) Continuation-in-part of application No. 16/431,688, filed on Jun. 4, 2019.
Application No. 16/431,688 is a continuation-in-part of application No. 16/292,235, filed on Mar. 4, 2019, now Pat. No. 10,453,309.

(51) Int. Cl. G07F 17/32; G07F 17/34

(52) U.S. Cl. CPC G07F 17/323; G07F 17/3276; G07F 17/34; G07F 17/3295

(57) ABSTRACT

A method, apparatus, and computer readable storage to implement a slot machine game which has a main game (pure chance or with an element of skill) and a skill bonus round. As the player plays the slot machine game, a skill bonus round can be randomly triggered. If the skill bonus round is randomly triggered, then the player can earn a score in the skill bonus round which can be placed on a leaderboard. Cash awards can be earned from winners on the leaderboard.

### CROSS REFERENCE TO RELATED APPLICATIONS

This application is a continuation in part of U.S. application Ser. No. 16/431,688, which is a continuation in part of application Ser. No. 16/292,235, filed on Mar. 4, 2019, both of which are incorporated by reference herein in their entireties.

### BACKGROUND OF THE INVENTION

### Field of the Invention

The present general inventive concept is directed to a method, apparatus, and computer readable storage medium directed to a game of chance which utilizes a feedback loop.

### Description of the Related Art

Gaming is a multibillion-dollar industry. There are games of pure chance (e.g. slots) and games of pure skill (e.g. chess) and a whole spectrum of games that have elements of both chance and skill. Wagering on games of skill is legal in many jurisdictions in the United States, whereas wagering on games of chance is illegal outside of licensed casinos and other like establishments in the United States.

What is needed is an improved way for players to win real money playing games of chance.

### SUMMARY OF THE INVENTION

It is an aspect of the present invention to provide an improved slot machine game.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a drawing illustrating numerous apparatuses that can play the game of chance (e.g. slot machine game) described herein, according to an embodiment;

FIG. 2 is a drawing illustrating a game of chance (e.g. slot machine game), according to an embodiment;

FIG. 3 is a drawing illustrating a skill bonus game, according to an embodiment;

FIG. 4 is a flowchart illustrating a method of implementing a game of chance with a skill bonus round, according to an embodiment;

FIG. 5 is a flowchart illustrating a method of implementing a game of chance with a skill bonus round in which a player can be guaranteed at least one entry into the skill bonus round, according to an embodiment;

FIG. 6 is a network diagram illustrating participants of the system, according to an embodiment;

FIG. 7 is a block diagram illustrating exemplary hardware that can be used to implement the game described herein, according to an embodiment;

FIG. 8 is a flowchart illustrating an exemplary method of implementing a skill bonus round using a leaderboard, according to an embodiment;

FIG. 9 is a flowchart illustrating an exemplary method of advancing a slot level, according to an embodiment;

FIG. 10 is a flowchart illustrating an exemplary method of advancing a leaderboard level, according to an embodiment;

FIG. 11 is a flowchart illustrating an exemplary method of playing a game in which triggering the bonus round is limited, according to an embodiment;

FIG. 12 is a flowchart illustrating a further exemplary method of playing a game in which triggering the bonus round is limited, according to an embodiment;

FIG. 13 is a drawing of a leaderboard display, according to an embodiment; and

FIG. 14 is a flowchart illustrating an exemplary method of utilizing a leaderboard to award prizes.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a game of chance (e.g. a slot machine game) in which players can legally play said game of chance without depositing real money. Games of skill are legal in some jurisdictions, and certain jurisdictions utilize tests such as the “predominance test” or the “material element test” in order to determine whether a game qualifies as a legal game of skill. The game of chance (e.g. slot machine game) has a skill bonus round which is predominantly skill based (the predominance test) or skill plays a material role in determining the game's outcome (the material element test). A skill bonus round can be a bonus round in which a player's skill (e.g., intelligence, manual dexterity, etc.) would improve the player's overall expected success (e.g., score) in the skill bonus round as the expected outcome for the player would not be purely left to chance; in other words a more skilled player would be expected to do better in the long run than a less skilled player. The bonus round is triggered by a random probability which is adjusted in real time for each particular player to result in each player having an overall expected award of the game that is the same. The bonus round trigger probability is adjusted based on the player's overall performance on the skill bonus round. The more skillfully the player plays the skill bonus round, the lower the bonus round trigger probability will drop, and the less skillfully the player plays the skill bonus round, the higher the bonus round trigger probability will rise. The results in the skill bonus round (also referred to as skill bonus game, etc.) may result in the player winning real money.

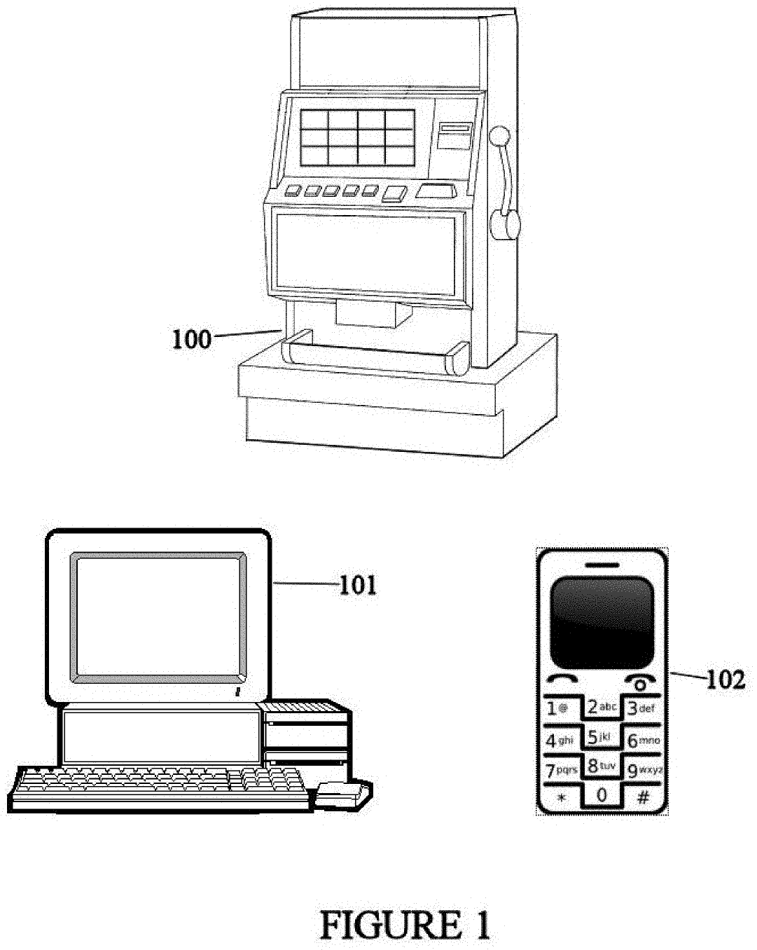

FIG. 1 is a drawing illustrating numerous apparatuses that can play the game of chance (e.g. slot machine game) described herein, according to an embodiment.

The game described herein can be played on an electronic gaming machine 100 that can be found in brick and mortar casinos or other venues such as internet cafes, etc. Cash (or cashless vouchers) can be inserted into the machine 100 using a bill acceptor which credits the machine with a respective amount of credits which can then be used to play the game, and winnings are paid out in the form of credits which can then be cashed out for cash or a cashless voucher (ticket) that can be redeemed for cash. The game described herein can exist on a software module pre-installed on the slot machine 100 or can be downloaded to the electronic gaming machine 100 from a central remote server.

The game described herein can also be played on a computer 101 such as a personal computer, laptop, etc. The game can be downloaded to the computer 101 and stored locally on the computer 101. Alternatively, the computer 101 can have an internet connection (not illustrated) so that the game can be served from a remote location and played and displayed on the computer 100. For example, the game can be played on an online social gaming casino in which the results are determined on a remote server and transmitted to the computer 101 so that the computer displays the results. The game can also be played on the computer 101 for play on a social networking site (e.g., FACEBOOK, etc.) wherein the game software can be launched from within the social network site itself.

The game described herein can also be played on a cell phone 102 or any other type of portable device, such as a tablet computer, etc. The portable device can implement any of the paradigms described above with respect to the computer 101 (e.g., online social gaming casino, social networking site, etc.)

An inventive concept herein relates to a game of chance (e.g. slot machine game) which has a non-skill main game (e.g. a reel spinning game) in which player skill plays no part in the expected award and also a skill bonus round. The non-skill main game can be a reel spinning game which spins reels which have symbols on them which stop at random positions. Based on the positions, different paylines can award awards to the player on winning combinations. During the non-skill main game, certain predetermined combinations will result in the skill bonus round being triggered, the skill bonus round involving skill (a skill of the player would affect the player's expected award). The success of the player in the skill bonus round would affect his/her chances of triggering the skill bonus round in future non-skill main games.

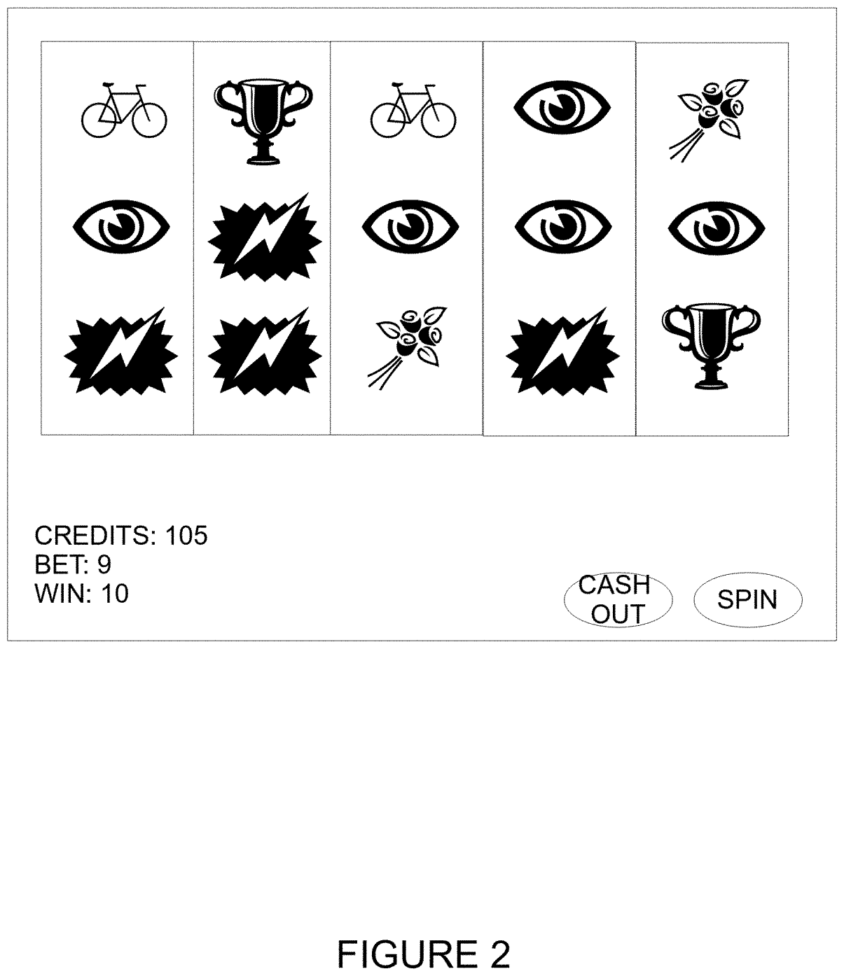

FIG. 2 is a drawing illustrating a game of chance (e.g. slot machine game), according to an embodiment. This can be used for the non-skill main game.

Five reels are shown (although any number can be used, for example from 3-6 or more). The reels (after a spin button is pressed) will spin and stop on a random combination. There are various paylines, which are a selection of symbols (typically 5, one from each reel) which will dictate winning combinations. Play of the non-skill main game would either be free (no coins/tokens/credits required to play) or could cost non-monetary credits which have no cash value and cannot be redeemed for cash but can be earned in various ways (such as watching advertisements, etc.) Winning payouts on the non-skill main game could result in in-game currency (e.g. non-monetary credits), entries into contests (e.g. sweepstakes) or entry into the skill bonus round.

All winning combination on active (paid for) paylines will award the player an award using a paytable. Table I below illustrates one example paytable. In an embodiment, the payout amount can be multiplied by the amount bet by the player. For example, if the player bets two non-monetary credits on each payline and one payline gets 5 clovers then the player will win 2,000 non-monetary credits. In another embodiment, the payout amounts are fixed and not based upon the amount bet. There can be no monetary awards won in the non-skill main game. Non-monetary credits cannot be redeemed for cash or exchanged for cash value credits.

TABLE I

| Combination | Payout |
|---|---|
| 5 clovers | 1000:1 |
| 5 eyes | 100:1 |
| 5 lighting | 80:1 |
| 5 trophies | 50:1 |
| 5 plants | 20:1 |
| 5 bicycles | 10:1 |
| 4 clovers | 500:1 |
| 4 eyes | 50:1 |
| 4 lighting | 30:1 |
| 4 trophies | 5:1 |
| 3 clovers | 25:1 |
| 3 eyes | 20:1 |
| All others | lose (−1) |

The reel spinning game involves no skill at all. The player simply presses the “spin” button and the reels will all stop at random positions. There is no way the player can affect where the reels stop.

The aforementioned slots game is just one example of a game of chance that can be utilized for the non-skill main game. Other games of chance can be used for the non-skill main game include but are not limited to Bingo, Roulette, War, etc. In an embodiment, a game of chance that can be used for the non-skill main game can be a game in which skill cannot affect or improve the outcomes at all (e.g. a slotmachine game).

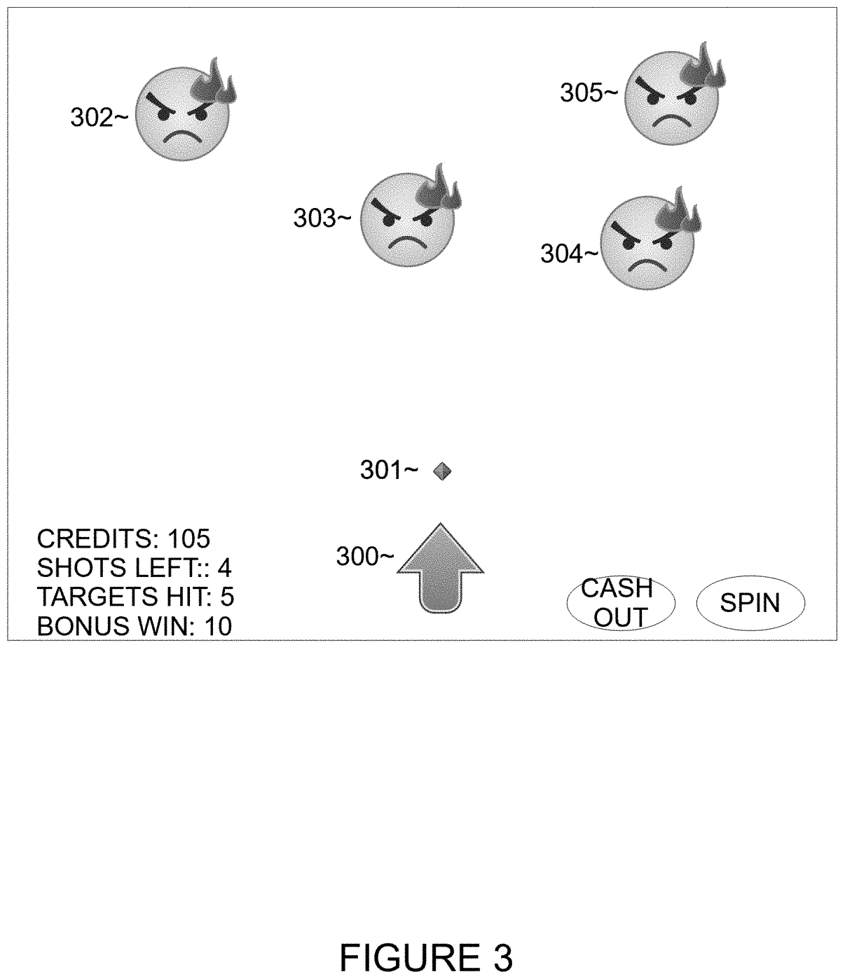

FIG. 3 is a drawing illustrating a skill bonus round, according to an embodiment.

There can be many types of skill bonus rounds. A skill bonus round is a bonus game (round) which is predominantly skill based (the predominance test) or skill plays a material role in determining the game's outcome (the material element test). There can be many types of skill such as dexterity, manual skill, intellectual skill, etc. For example, in this particular example, the player has a predetermined number of shots (e.g. 10) to hit as many targets 302, 303, 304, 305 as possible. The player can move his/her launcher 300 around and fire a shot 301 at any time the player wishes. Once the player shoots all of his/her predetermined shots, then the game ends. The player's prize in the skill bonus round could be based on the number of hits, the time to completion, the accuracy of each hit, etc. Dexterity/manual skill refers to the ability of a player to utilize fast reflexes and accuracy in playing a visual video game, for example by firing at a target accurately, moving an icon to contact or avoid other icons, etc. There exist a large number of video games, and many of them are determined by dexterity/manual skill. Skill can also refer to intellectual skill, such as the player's ability to answer trivia questions, solve puzzles, find hidden objects, etc. While this is just one example, the skill bonus game can be any type of game which is predominantly skill based (the predominance test) or skill plays a material role in determining the game's outcome (the material element test). Of course, a player who has more physical skill (or intellectual skill, etc.) could do better in a skilled game than a player who has less physical skill (or intellectual skill, etc.) The skill bonus round would end after a condition occurs (e.g., a predetermined amount of time expires, a fixed number of shots the player can take were all used up, etc.) and then the game returns back to operation 401 where the player can play the non-skill main game again.

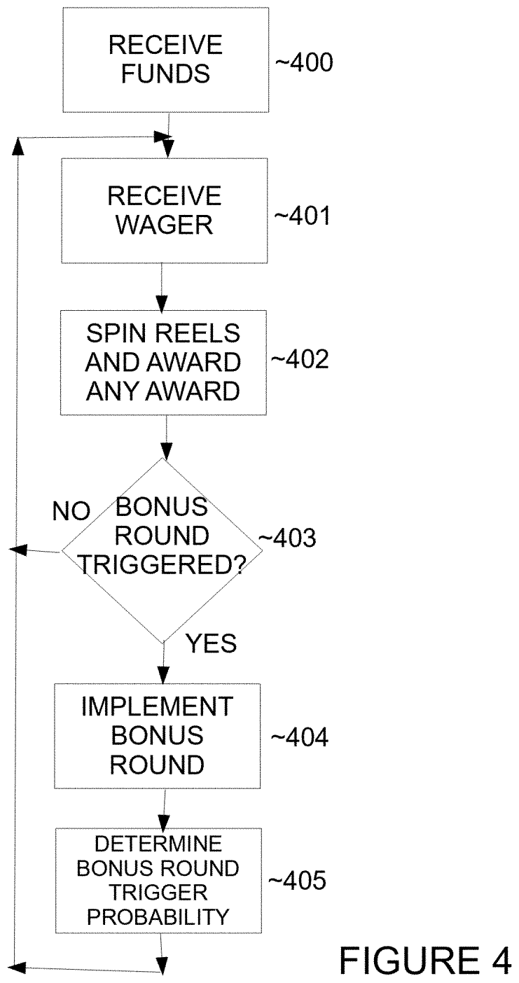

FIG. 4 is a flowchart illustrating a method of implementing a game of chance with a skill bonus round, according to an embodiment.

The method can begin with operation 400, which receives funds from the player. In the embodiment which is played on a physical slot machine, this can be done as known in the art, for example the player inserts cash (or a cashless ticket) into a bill acceptor (also known as bill validator), pays electronically, uses a payment card, etc. The money deposited then is converted into playable credits.

With regard to the embodiment being played online without having to use real money (cash equivalent) to play, the player will receive funds (non-monetary credits which can be used to initiate the main game) when they open the social gaming casino, social networking site, etc., or in exchange for performing advertising actions (e.g., watching a video, downloading a mobile application, completing a survey, etc.). Players will not deposit real cash in exchange for non-monetary credits. Non-monetary credits have no cash value and are awarded to the player at no monetary cost.

From operation 400, the method proceeds to operation 401, which receives a wager (in non-monetary credits) from the player. Typically, the player indicates how much he/she wishes to wager and then presses a “spin” button (a game initiation). The spin button deducts the wager amount (non-monetary credits) from the player's current amount of non-monetary credits (credit meter) and then initiates the spin of the reels (the non-skill main game). If the player is out of non-monetary credits, the player may perform an advertising action (e.g., watching a video, downloading a mobile application, completing a survey, etc.) to add funds (non-monetary credits) in operation 400. There will not be an unlimited number of advertising actions available to the player, so it is possible the player may have to close the social gaming casino, social networking site, etc. and come back after some duration of time (e.g. one hour to as much as one day). If the player has no non-monetary credits, then the player cannot play the game and hence will not proceed to operation 402.

From operation 401, the method proceeds to operation 402, which initiates the game of chance (the non-skill main game). In this particular non-skill main game (slot machine game), the reels are spun. This is done as known in the art. Each reel is a (physical or virtual) strip comprising a set of symbols (e.g., 32 or any other amount). Each reel will stop on a random stop utilizing a random number generator, and a final position of the reels is where all reels are stopped so that it can be determined whether the player wins an award based on the final position.

In addition, if the final position forms any winning combination on active paylines, those winning combinations are all paid (e.g., the non-monetary credit meter which displays an amount of non-monetary credits the player has increases by the respective amount.) The non-monetary credits can be in game non-monetary credits, sweepstakes tickets, etc. All awards that are won in the non-skill main game are paid out in non-monetary credits.

From operation 402, the method proceeds to operation 403, which determines whether the skill bonus round is triggered. The skill bonus round can be triggered in a number of ways. In this particular non-skill main game (slot machine game), the skill bonus round could be triggered based upon a predetermined combination that appears in the final combination after the reels spin. For example, three or more “bonus” symbols appearing on the final combination could trigger the bonus round. Another way the skill bonus round could be triggered is a random determination (not based upon the final combination). For example, if a given probability occurs (e.g., 1/40, 1/60, etc.) then the skill bonus round would also be triggered (a bonus round trigger probability). In yet another way, a bonus round symbol could be programmed to appear on the reels to trigger the skill bonus round based on the bonus round trigger probability (in other words, based on the bonus round trigger probability if it is determined to trigger the skill bonus round then the bonus round symbols would appear on the reels which would trigger the skill bonus round, and if it is not determined to trigger the skill bonus round then the bonus round symbols would not appear on the reels). The player would typically not know what his/her bonus round trigger probability is or that it is constantly changing based on both the player's own performance (as described herein) and the average performance of others on the platform (as described herein). If in operation 403, the skill bonus round is not triggered, then the method returns to operation 401 which receives another wager.

In another embodiment, the bonus round trigger probability can be implemented in a “mini-game” such as a wheel. For example, after each spin, a wheel can spin (or any other visual indicator) which would be programmed such that the wheel would land on a “bonus round” (which would trigger the skill bonus round) slice (versus an empty slice which would not trigger the skill bonus round) with a probability of the computed bonus round trigger probability.

If in operation 403, the skill bonus round is triggered (in any manner), then the method proceeds to operation 404, which implements the skill bonus round. This is a skill bonus round such as that illustrated and described with respect to FIG. 3. The skill bonus round can be any type of game which is predominantly skill based (the predominance test) or skill plays a material role in determining the game's outcome (the material element test). A more skillful player would typically fare better (earn more real money prizes) compared to a player who is less skillful. The skill bonus round would be completed and a real money prize (if any), such a cash value credits (credits which are redeemable for cash, etc.) is awarded to the player based on how the player performed in the skill bonus round.

From operation 404, the method proceeds to operation 405, which determines a bonus round trigger probability. The player's performance in the skill bonus round (e.g., all of a player's previous performances on a particular skill bonus round (there can be multiple different skill bonus rounds) can be averaged) will affect the probability that the skill bonus round would be triggered on subsequent plays of the game of chance by the same player in operation 403. The game machine/platform would ascertain whether the same player is playing by an identification mechanism, such as the player using a player's card, the player logging in to the game, the game tracking the player's IP address, etc. Performance in the skill bonus round by a particular player will directly affect bonus round trigger probabilities (in operation 403) for plays of the game by that same player (because the player's average award in the skill bonus round is evaluated against the overall average award in the same skill bonus round for all players on the platform). Note however, performance in the skill bonus round by a particular player can indirectly affect bonus trigger probabilities for other players because each player's average award in the skill bonus round will be evaluated against the overall average award awarded in the skill bonus round for all players.

Thus, the interaction between the player's skill in the bonus round and how it affects the bonus trigger probability after the slot game is played is a “feedback loop.” The player's performance in the skill bonus round is continuously self-adjusting the bonus trigger probability which is used to determine when the skill bonus round is triggered (initiated).

Since no real money will be won in the non-skill main game (game of chance with no skill being utilized, in other words player skill has no effect on the player's expected award), the overall game will have an overall average award (in cash value credits), which is what the player would win in the skill bonus round. Note that the average award of an individual bonus game will vary based upon the skill of the player, which in turn will influence the probability that the player triggers the bonus game (the “feedback loop”). Thus, a player who is more skilled will have the probability that the bonus round is triggered (in operation 403) reduced, while the player who is less skilled will have the probability that the bonus round is triggered (in operation 403) increased.

For example, an overall average expected award of the overall game can be 0.9. In other words, for each play of the non-skill main game, the player's average award will be 0.9 cash value credits. The game could be designed to adjust the probability of triggering the skill bonus round in order to keep players all winning an average award of 0.9 cash value credits. For example, the bonus round could be triggered by 5% of the spins. That means the average cash value credit award won when playing the non-skill main game would be 18 cash value credits awarded on the skill bonus round (0.05*x=0.9, hence x=18).

The cash value of a cash value credit could be any number from $0.01 to $100 to much greater. Each of these three variables (overall expected award, bonus round trigger percentage (or probability) and amount of cash value credits won in the skill bonus round) can be modified for a pre-determined period of time. In other words, on a given day the average award in cash value credits won could increase, while holding the overall expected award constant, thus causing the bonus round trigger percentage to decrease.

Now consider a player who is more skilled and who earns on average 23 cash value credits each time he/she enters the skill bonus round. At a bonus round trigger probability of 5%, this means that this player would earn 0.05*23=1.15 average cash value credits for each play of the non-skill main game (the cash value credits would be earned in the skill bonus round if it is triggered). This could be considered too high, and the game would desire to reduce the probability that the bonus round is triggered for this particular player. To put the average award (in cash value credits) of the bonus game back at 0.9 (like the average player), the probability that the bonus round will be triggered will be 0.9/23=0.03913. In this manner, by reducing the bonus round trigger probability for this particular skilled player, the overall average award can be adjusted to match what the average player is earning.

Thus, the game can be configured so that each player can have a deterministic (predetermined in the long run) cash value award. For example, the award can be a particular overall award, e.g. 0.90 cash value credits per play of the non-skill main game.

The deterministic award can also be a dynamic overall award, for example the average skill bonus round award of all players on the system which can change over time.

Along the same lines, a player who plays the skill bonus round less skillfully than the average player on the platform would have the bonus round trigger frequency (probability) increased (using the same math above) in order to improve this player's overall average award playing the game.

Note that average bonus award can be measured by taking the average of all player's awards for the bonus round (either for all time or over a predetermined past period of time such as one month, one year, etc.) Each individual player's own bonus round average score can be averaged for all of time or over a predetermined past period of time such as one month, one year, etc.

In another embodiment, the bonus round trigger probability would be kept constant for all players, but players would only earn cash value credit, when they performed standard deviations above their personal mean. In other words, after some time a player's performance in a particular skilled bonus game would be known to the system and if that player performed for example 2 standard deviations above his/her average score, then the player would earn a certain number of cash value credits. In this way, each player is competing against himself/herself. Obviously, protections would need to be put in place to prevent players from gaming the system.

Note that various different games of chance (with different game play, payouts, etc.) can be offered with various different types of skill bonus rounds. Each type of skill bonus round would have its own average award. So, for each different skill bonus round (e.g., shooting, racing, trivia, etc.), the system would store each player's own individual scores (bonus award) so each particular player's awards can be averaged to compute the player's own bonus round trigger probability using their average award for each respective bonus round. For each different skill bonus round, the system/platform would also store everyone's (all players) bonus awards so the overall average award for all players could be averaged for that particular skill bonus round.

Note that over time, for each skill bonus round, the overall average award might increase over time as the players get more practice and improve their performance in the skill bonus round. If a player does not improve his/her skill for the skill bonus round (and plays at the same skill level), then this player's bonus trigger probability would increase so that the player's overall average award would match the average player on the platform. Similarly, for a skill bonus round, if the overall average award decreases over time (not likely), then a player who still plays over time at the same skill level will have his/her bonus trigger probability increased so that the player's overall average award would match the average player on the platform.

Note that described above is a system where the average of all players' (on the platform) awards (of cash value credits) in a skill bonus round is computed, and each individual player has his/her own respective bonus round trigger probability adjusted (based on the individual player's average award in the same bonus skill round) so that the individual player's overall average award (of cash value credits) for the overall game (plays of the non-skill main game which may also trigger the skill bonus round) matches what the average player on the platform is being awarded in cash value credits for their overall game. In another embodiment, instead of adjusting the bonus trigger probability so that a particular player's average award (in cash value credits) when playing the overall game would match the average award (of cash value credits) for all players on the platform who play the overall game, the bonus trigger probability is adjusted so that each player's (all players on the platform) average award in cash value credits when playing the overall game is a predetermined amount chosen by the game designers (e.g., 0.95 cash value credits per single play of the non-skill main game). In this embodiment, the skill exhibited by players in the skill bonus round would not affect other player's expected values (and would not affect other player's bonus trigger probabilities).

Note that the methods described herein can be applied to physical or online slot machine games. In an embodiment, the methods described herein can also be applied to an online casual (free play game found on a social networking site) or social gaming casino. That is, players can register with a web site hosting the game (by a gamer server), and the players can then play the game without depositing real money.

Note that the physical slot machine version could use real money (credits redeemable for cash) for both initial wagers (made to play the non-skill main game) and for all awards won (both in the non-skill main game and the skill bonus round). The online casual or social games would not use real money (or credits redeemable for real money/cash) to play the games (e.g. spin the reels) but would use non-cash credits to play the games even though the skill bonus round (which is triggered randomly but would not cost the player additional credits) would award real cash awards (e.g. cash value credits).

While a player is playing, the players would perform advertising actions (e.g., view advertisements on or within the game, watch videos, install mobile apps, complete surveys, etc.) Performing advertising action could also earn a player some additional non-monetary credits (used to play the non-skilled main game). Advertisers would pay (in real money, using an electronic funds transfer, credit card payments, etc.) the platform itself (or its operators) cash money to advertise on the platform (web site), to have surveys filled out by players, for apps that are downloaded by players, etc. The advertising money constitutes the prize pool (with a commission taken out (e.g. 20%) for the game/platform operators), and the prize pool is what is used to award the awards (paid in cash value credits which can be redeemable for money/cash) that the players would win in the skill bonus round.

One benefit of the current methods described herein as applied to a social gaming casino or social networking site is that players can enjoy playing games of chance with the potential to win real cash awards by playing games of skill. The game would be configured as described herein to equalize the overall average awards of all of the players (by adjusting the probability of triggering the bonus round), as such, no skilled player could (in the long term) take advantage of the game platform by playing skillfully and winning more than other players.

Described above is a method in which the non-skill main game is purely random and player skill cannot affect or improve (or worsen) the player's expected award. In an alternative embodiment, the non-skill main game can actually incorporate an element of skill which can affect the player's expected award so long as the non-skill main game does not have a significant skill aspect (for example it does not satisfy legal tests for being a legal game of skill such as the material element test or the predominance test). So, in other words, in this embodiment, the non-skill main game can actually be a game in which player skill can improve (or reduce) the player's expected award. For example, the non-skill main game can be a game like blackjack, etc. However, everything else described herein remains the same (e.g., the player still uses non-monetary credits to play the non-skill main game). Typically, the non-skill main game would be a different game than the skill bonus round.

One other such game category that can be used for the main game (also referred to herein as the “non-skill main game”) which is implemented in operations 402 and 506 includes an element of skill but does not have a significant skill aspect (for example it does not satisfy legal tests for being a legal game of skill such as the material element test or the predominance test) can be “match 3” games, in which a player matches three or more like symbols in a grid of random symbols, and upon a match the matching symbols disappear and symbols will cascade downward with new random symbols added to replace the missing ones (e.g., CANDY CRUSH). This is just one example of many games of this nature in which users' skill does affect the results, but chance plays a deciding role in determining the final outcome.

In a further embodiment, a player can earn non-monetary credits by performing an advertising action (e.g., watching an advertisement, filling out an online survey, etc.) and be provided a guaranteed entry into the skill bonus round. For example, the player can watch an advertisement and earn 25 (or any other amount) of non-monetary credits. Along with the new 25 earned non-monetary credits, the player will be guaranteed an entry into the skill bonus round. Note that this is not necessarily an extra entry into the skill bonus round, only a guarantee that the player will enter the skill bonus round at least once while playing the new non-monetary credits the player has received (which includes playing the winnings from those non-monetary credits).

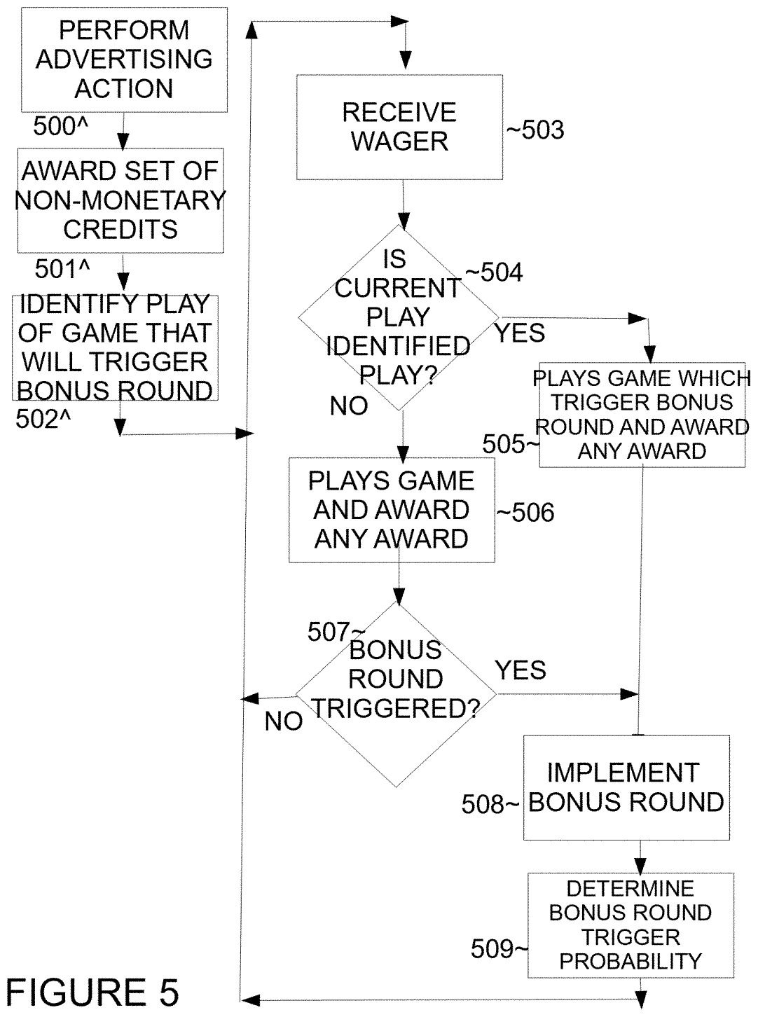

FIG. 5 is a flowchart illustrating a method of implementing a game of chance with a skill bonus round in which a player can be guaranteed at least one entry into the skill bonus round, according to an embodiment. The method operates similarly to the method illustrated in FIG. 4 (and the accompanying description), and any aspect of the FIG. 5 method not described can be implemented utilizing the other methods described herein.

In operation 500, the player performs an advertising action. This can be performed as described herein, such as watching an advertisement, filling out an online survey, etc. An online survey is where the player answers questions using his/her computing device and the answers are transmitted electronically using the internet to a game server (or any other database/server) so that all of the answers from all players who filled out the online survey can be tabulated. So long as the player has non-monetary credits left over from a previous time the player performed the advertising action (or alternatively so long as the player has non-monetary credits (at least one) left over from any source), there would not be an advertising action available to the player. In other words, the player would not begin operation 500 as long as the player already has existing non-monetary credits in the player's account. However, the player could always begin operation 500 when the player has no non-monetary credits left. So long as the player has any non-monetary credits left, the player could not proceed to operation 500 but could always proceed to operation 503 (skipping operations 500-502) to spend one (or more) of the player's non-monetary credits and play (operations 503 and onward). Each time the player plays (operation 503) non-monetary credit(s) (the wager) is deducted from the player's account. The player's account would typically store the player's current total of non-monetary credits, so the player can close the social gaming casino, social networking site, etc. (e.g. sign out) and come back at another time and pick up where the player left off. Only once the player has played (spent) all of the non-monetary credits that the player currently has, can the player then earn additional non-monetary credits by performing another advertising action.

From operation 500, the method proceeds to operation 501, which awards the player a set of non-monetary credits in response to performing the advertising action. For example, the player can receive 25 (or any other number) of non-monetary credits for performing the advertising action (in operation 500). There will not be an unlimited number of advertising actions available to the player, so it is possible the player may have to close the social gaming casino, social networking site, etc. and come back after some duration of time (e.g. one hour to as much as one day). Note that the player may only be allowed to receive a new set of non-monetary credits only once in a temporal time period (e.g., daily (per 24 hours), hourly, etc.) So for example, if the player received five sets (or any other number that is chosen) of non-monetary credits on a particular day, the player may have to wait until after midnight (or other cutoff point) in order to perform another advertising action and be able to be awarded another set of non-monetary credits. A set of non-monetary credits is a quantity of two or more non-monetary credits (e.g., 2-25 or more) with the number of non-monetary credits in the set typically being predetermined. Alternatively, the player may have to wait the temporal period from the last time the player received the set of non-monetary credits (e.g. if the player receives a set of non-monetary credits, the player would have to wait 24 hours from that time of receiving the non-monetary credits in order to be able to receive more non-monetary credits). If a player does not have any non-monetary credits, then the player cannot play the main game (e.g. the method would not proceed past operations 401 and 503). Typically, a player cannot perform an advertising action and receive a new set of non-monetary tokens until all of the player's current set of tokens has been played meaning a current balance of non-monetary credits is zero.

From operation 501, the method proceeds to operation 502, which identifies a particular play of the main game that is guaranteed to trigger the skill bonus round. A particular play of the main game is when the game is initiated in operation 506. So for example, if the player is awarded 25 non-monetary credits, the system may randomly choose a particular play (integer) from (including) 1 to (including) 25 (or however many non-monetary credits were awarded) to be the identified play. For example, if the identified play is 3 (as in the 3^{rd} play from the current time), then on the third time the player plays (operation 506 is executed), this play is the identified play and the player will be guaranteed to trigger the skill bonus round. Typically, the player will not be informed which play is the identified play. Typically, only one guaranteed entry into the skill bonus round is provided but in another embodiment, more than one guaranteed entry can be provided (e.g., 2-5 or more).

From operation 502, the method proceeds to operation 503, which receives the wager (in non-monetary credits). This is performed as described with respect to operation 401. If the player has no non-monetary credits, then the player cannot play the game and hence will not proceed to operation 504.

From operation 503, the method proceeds to operation 504, which determines whether the current play is the identified play (determined in operation 502). A counter would proceed to count the number of plays from the time the player has received the non-monetary credits (in operation 501). If in operation 504, the current play is not the identified play, then the method proceeds to operation 506.

If in operation 504, it is determined that the current play is the identified play, then the method proceeds to operation 505, which plays the main game (e.g., spins the reels or other type of game) and the skill bonus round is triggered, and all awards earned are awarded. The main game is played as generally described in operation 402 (and same as operation 506) but with the difference that the skill bonus round will definitely be triggered. In operation 505, the skill bonus round will be triggered during the play of the main game and the player would typically not be aware that the skill bonus round was predisposed to be triggered (instead of being a purely random determination which is what typically happens in operations 506-507). For example, if the main game is a slot machine game and the skill bonus round is triggered when a special symbol (or combination of symbols) appear, then the special symbol (or combination of symbols) would be programmed to definitely appear and hence trigger the skill bonus round. If the main game is blackjack and the bonus round is triggered when a particular combination of cards (e.g. two diamond cards in the player's initially dealt two card hand) then the player in operation 505 would be programmed to receive two diamond cards so that the skill bonus round would be triggered. Whatever other aspects of the main game which are not related to the skill bonus round being triggered could still be random. For example, in a slot game, if the player needs to receive a special symbol on the last reel to trigger a skill bonus round, then the last reel would definitely display the special symbol to trigger the skill bonus round but the other reels could still spin and stop on random symbols. Now that the skill bonus round is triggered, the method would proceed to operation 508 which would implement the skill bonus round. The skill bonus round would be implemented in operation 508 without regard that the skill bonus round was actually triggered via operation 505 (instead of operation 507). In other words, the skill bonus round would not discriminate between guaranteed triggers of the skill bonus round and purely random triggers of the skill bonus round. In an alternative embodiment, if the skill bonus round was not guaranteed a paytable therein could be different than a paytable used for a skill bonus round which was guaranteed. Note that even if the skill bonus round was not deterministically triggered for this play (by reaching operation 505), it is still possible that the same play could have randomly triggered the skill bonus round anyway (in operation 507). So, the identified play works as a “guarantee” to ensure that the player will trigger the skill bonus round at least once during the play of the set of non-monetary credits awarded in operation 501 (although of course the player may end up triggering the skill bonus round more than one time).

From operation 504, if it is determined that the current play is not the identified play, then the method proceeds to operation 506, which plays the main game and awards any earned award (as described in operation 402). The main game typically incorporates randomness, that is, one or more random determinations are utilized in producing the game results (e.g., random cards dealt, reels which stop on a random symbol, etc.) The main game can be purely random (no human skill involved) or can involve player skill (but still incorporates randomness as well, for example the player can be dealt random cards but must make a skill decision on how to proceed). Note that if the identified play is N, and the player wins an additional 5 non-monetary credits, then this can be handled in a number of ways: the identified play can still be N (no change), or the identified play can now be N+5 (pushed back by the number of non-monetary credits won), or the identified play can now be selected randomly again out of the remaining plays that the player has. For example, if the identified play was play 10 (decided in operation 502) and the current play is 4 (meaning the current play is four spins after the award of the non-monetary credits meaning the skill bonus round will definitely be triggered in six more spins), and the player wins 7 more non-monetary credits, then the identified play can now be either: 10 (same as before), 17 (10+7), or a new random integer determination between 4 (the current play) and 32 (32 being 25 (the number of non-monetary credits earned plus the number of credits recently won). Ultimately, the inventive concept is that the player will be guaranteed to trigger the skill bonus round (at least once) during play of the main game for every award of each set of the non-monetary credits (awarded in operation 501) and it does not necessarily matter when the guaranteed skill bonus round play/spin will occur as long as it occurs during play of the non-monetary credits (including any winnings) that were awarded to the player in operation 501.

From operation 506, the method proceeds to operation 507, which determines whether the skill bonus round was triggered. This is performed as described in operation 403. If the skill bonus round is not triggered, then the method returns to operation 503 wherein the player can play again. If in operation 507, the skill bonus round was triggered, then the method proceeds to operation 508.

In operation 508, the skill bonus round is implemented. This is performed as described in operation 404.

From operation 508, the method proceeds to operation 509, which determines the skill bonus round trigger probability. This is performed as described in operation 405. From operation 509, the method returns to operation 503.

In this manner, the player will be rewarded for performing the advertising action by being guaranteed to receive at least one skill bonus round while they play out the set of non-monetary credits they were awarded for performing the advertising action.

In another embodiment, once a player performs an advertising action (such as watching an advertisement), the player receives one (or more) guaranteed entry (as described herein) into the skill bonus round (the player will not be able to perform another advertising action until the player is out of non-monetary credits and has therefore played his/her guaranteed entry into the skill bonus round). Thus, in this embodiment, when the player performs an advertising action, at some point (while playing the main game) the player will receive his guaranteed bonus entry and play the skill bonus round. There will be no opportunity to trigger the skill bonus round based on chance. In other words, on a particular spin of the main game, the probability of the skill bonus round being triggered is either 0% or 100% (guaranteed).

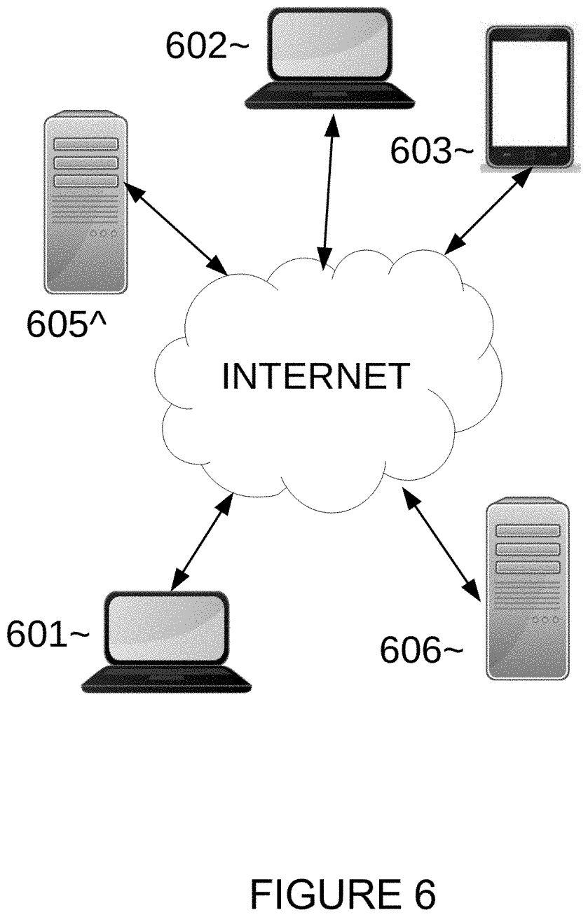

FIG. 6 is a network diagram illustrating participants of the system, according to an embodiment.

Any number of players (e.g., 1 to 10,000 or more) can be playing the game described herein remotely and simultaneously such as remote players 601, 602, 603. Remote players can play on any type of computing device, such as a cell phone, laptop, PC, tablet, etc. A game server 605 can implement the game (and all methods described herein) which would enable the remote players to play the game on their computing devices (but typically all game results are determined on the game server 605 so that no players can hack into the system and cheat). One or more advertising servers 606 can be used to serve advertisements to the game server 605 so that those advertisements would be displayed on the players' computing devices while they are playing the game. The advertising servers 606 (or more particularly the company who sponsors each such advertising server 606), would pay to have their advertisements displayed within or on the game. For example, each time an advertisement is displayed it could cost the sponsor one cent. The fees to pay for the advertising can be wired from the advertising server 606 (or another server/account located elsewhere on behalf of the company sponsoring the advertisements) to the game server 605 (or another server/account located elsewhere on behalf of the company sponsoring the game). When players win real cash awards, the winnings are stored in their accounts. Players can cash out their awards at any time by requesting an electronic transfer of funds from an account associated with the game server to the player's personal account (e.g., bank account, etc.) Cash awards can also include gift cards, which can be activated by an email sent to the winner. A cash award can also include a check sent in the physical mail. In an embodiment, instead of cash awards, a winner could receive a physical good (e.g., a cellphone) or service. Note that a valuable award can comprise a cash award, a physical good, and a service.

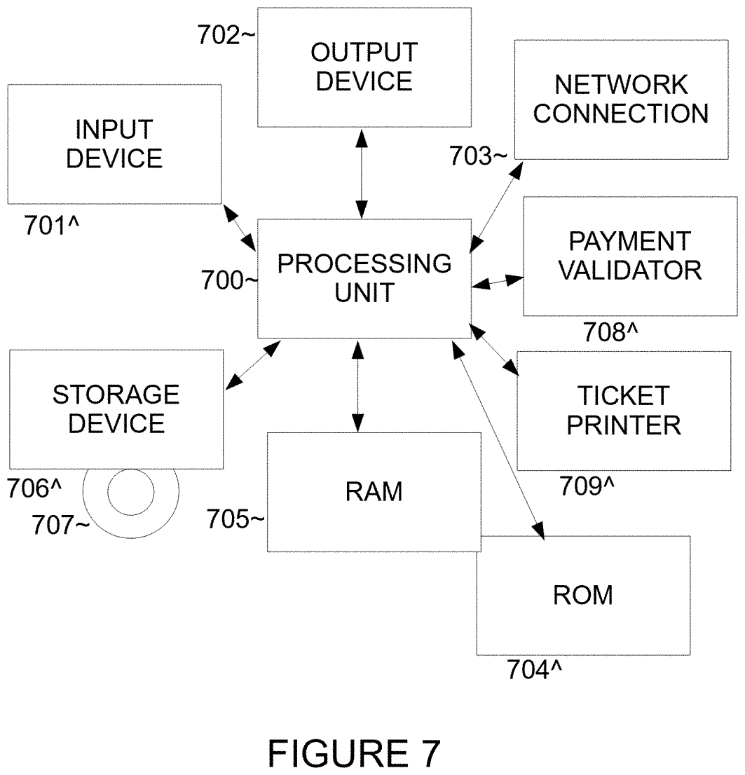

FIG. 7 is a block diagram illustrating exemplary hardware that can be used to implement the game and methods described herein, according to an embodiment. The hardware in FIG. 7 can be used to implement a computer implementing the game described herein and/or a server that is serving the game to remote computers which are displaying/playing the game to respective players.

A processing unit 700 can be a microprocessor and associated structure (e.g., bus, cache, clock, etc.) which can be connected to an input device (e.g., touch-screen, keyboard, mouse, buttons, etc.) and an output device (e.g., touch-screen, CRT, monitor, etc.) The processing unit 700 can also be connected to a network connection 703 which can connect to a computer communications network such as the Internet, Wi-Fi, LAN, WAN, etc. The processing unit 700 can also be connected to a ROM 704 and a RAM 705 as used in the art. The processing unit 700 can also be connected to a storage device 706 which can be nonvolatile storage device (e.g., BLU-RAY drive, CD-ROM drive, hard drive, EPROM, etc.) A non-transitory computer readable medium 707 (e.g., BLU-RAY disc, CD-ROM, hard disc, etc.) can be read by the storage device 706 and can store programs and assets that can cause the processing unit 700 to perform any of the methods described herein. The ROM 704 and RAM 705 can also be loaded with instructions that can cause the processing unit 700 to perform any of the methods described herein.

In the embodiment played on a physical gaming machine, the processing unit 700 can also be connected to a payment validator 708 (in the case where the game is being played on a physical electronic gaming machine). The payment validator can be a bill acceptor which accepts currency, identifies it as being valid (typically by using an optical scanner), and then credits the inserted bill amount to the machine (for example insertinga $10 bill will credit the machine with $10 in credits (these would typically be cash-value credits)). The bill acceptor can also accept cashless tickets as part of a ‘ticket-in-ticket-out” system, in which tickets (cashless vouchers) have cash value and can be inserted into the payment validator 608. The validator 608 validates the ticket (typically be optically scanning a bar-code) and crediting the machine with the respective amount of credits. The payment validator 608 can also include a card reader which can read cards (e.g., with a magnetic stripe or other electronic encoding) so that an account number can be accessed. The cards can be a credit card, player loyalty card, specific casino payment card, or any card that can provide electronic access to a monetary amount owned by the player (owner of the card) which the player can utilize for playing the slot machine. If such a card is used, then the player can optionally enter (using a keypad) an amount the player wishes to withdraw from the account associated with the card to credit to the slot machine.

In the embodiment played on a physical gaming machine, the processing unit 600 can also be connected to a ticket printer 709 (in the embodiment where the game is being played on a physical electronic gaming machine) which can print tickets (cashless vouchers). When the player cashes out on the slot machine (indicated to the machine that the player wishes to cash out and terminate by, typically by pressing a button), a ticket is printed by the ticket printer 709 which carries the amount of credits (all kinds of credits, including non-monetary credits and cash value credits) left on the machine. This ticket can then be used to play other machines in the casino by inserting them into that machine's payment validator. The ticket can also be used to redeem for cash by inserting it into a ticket redemption machine (kiosk) which receives a ticket, validates it (typically by scanning the barcode), and then dispenses an identical amount of cash to what the ticket's value is.

All components herein can be distributed across different such components as needed. For example, a single server as mentioned herein can be distributed across numerous different servers and locations. A processor (or processing unit) can also be distributed across multiple processors in a same or different computer (at a same or different location). The electronic components described herein represent an abstraction but it can be appreciated that the computer systems implementing the methods herein can be more numerous and interconnected than illustrated herein.

If a player is playing the game described herein on a social gaming casino, social networking site or other type of hosted environment, then the player's computer would cooperate with the respective server in order to present the game to the player. The player's computer would perform the instructions necessary to display the game while the remote server can determine the results (e.g. the final arrangement) and communicate this result via the Internet to the player's computer so that the player's computer can accurately display the result. The remote server may track and account for all credits wagered and all real awards won, while the player's computer can display the amount of real cash awards won at the direction of the remote server so the player cannot tamper with these amounts. The player's computer can also display their current amount of non-monetary credits (which cannot be cashed out for cash) and their current amount of cash value credits they have won that they can redeem (cash out, withdraw, etc.) All games described herein are considered to be played on the site described herein. Note that “prize” as used herein is synonymous with “award” (when used as a noun).

Note that in a further embodiment, an online game (as described herein) can implement a skill bonus round which awards prizes via a leaderboard. For example, a player would earn a score when playing the bonus round (typically the higher the score the better for the player), and the player's score (after completing the bonus round) would be added to a leaderboard. Periodically (e.g., daily, every 48 hours, weekly, etc.) the leaderboard would expire and the highest scores (e.g., top 1, top 3, top 10, etc.) on the leaderboard would win prizes for their respective players. Note that a leaderboard's score can also be such that the lower the score the better, for example the leaderboard could contain a time a player needed to perform a particular task. Thus, instead of awarding a prize contemporaneously with completion of the bonus round, a player's score goes into the leaderboard and the best score(s) after the leaderboard expires will win a respective prize(s).

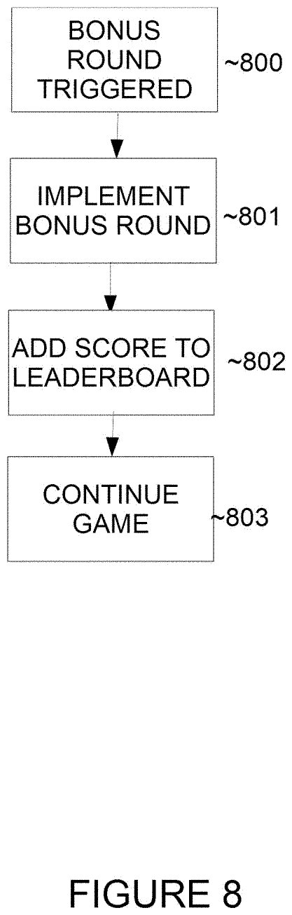

FIG. 8 is a flowchart illustrating an exemplary method of implementing a skill bonus round using a leaderboard, according to an embodiment.

The method can begin with operation 800, in which the bonus round is triggered. This can be done as set forth in operations 403, 507, 1106, or 1206. Operations 801-803 will be implemented after the bonus round is implemented. Thus, any embodiment described herein can be modified to utilize a leaderboard to award prizes.

From operation 800, the method proceeds to operation 801, which implements the bonus round (typically a skill bonus round which involves player skill). This can be done as described in operations 404 and/or 508. However, note that during play of the bonus round, the player will be awarded points based on the success of the player's play (typically, the more points the player earns the better). For example, the skill bonus round can be a shooting game in which the player earns a point each time the player successfully shoots a target with the game ending after a predetermined amount of time. Thus, the higher the score (in points) the better for the player. Any such skill bonus round can be implemented, wherein points are awarded to the player for successful actions.

Once the bonus round in operation 801 is completed, the method proceeds to operation 802, which adds the score earned in operation 801 to the leaderboard. Note that there can be a number of different leaderboards with each leaderboard having its own level (as further explained). The player's unique identifier (e.g., account name, etc.) is added to the leaderboard along with his/her respective score. Note that if the same player is already on the same leaderboard, then only the higher score is used. For example, if the current score is lower than the same player's score already on the leaderboard, then the current score is not put on the leaderboard. On the other hand, if the current score is higher than the same player's score already on the leaderboard, then the current score is put on the leaderboard and the previous player's score on the leaderboard is removed. Thus, each player can only have at most one score (entry) on the same leaderboard at one time.

Thus, in this embodiment, it is important to note that the player does not win a prize (e.g., a cash award) immediately after completing the bonus round. Rather, the score will be added to the respective leaderboard and only when that leaderboard expires would the player then win a prize (assuming the player still qualifies to win a prize on the leaderboard when the leaderboard expires). The leaderboard can expire on a fixed temporal basis, for example, every day at midnight, every 2 days at noon, every week at a particular time, etc. Once completing the bonus round, the player will have to wait until the leaderboard expires before winning a potential prize, which would take the amount of time left before the leaderboard expires. Thus, the player, once completing the bonus round, would typically have to wait (e.g., more than a minute, more than an hour, etc.) before actually being awarded a prize.

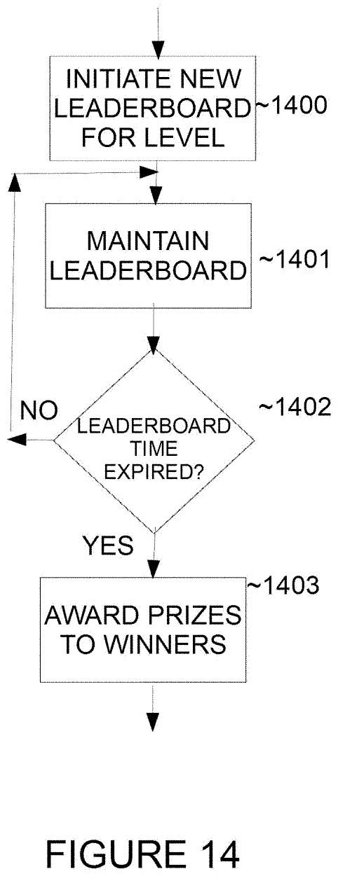

From operation 802, the method proceeds to operation 803, which continues the game (e.g., enables the player to make another slot spin on the main game). Note that when the leaderboard (used in operation 802) expires, then the respective prizes will be awarded to the respective winning players (see FIG. 14).

Note that in an embodiment, there can be a plurality of slot levels (also referred to as a main game level). Each slot level could (optionally) have different payouts, symbols, etc. The slot level would advance (increase by one) each time a predetermined combination of symbols would result from a spin (e.g., all cherry symbols on a payline, etc.)

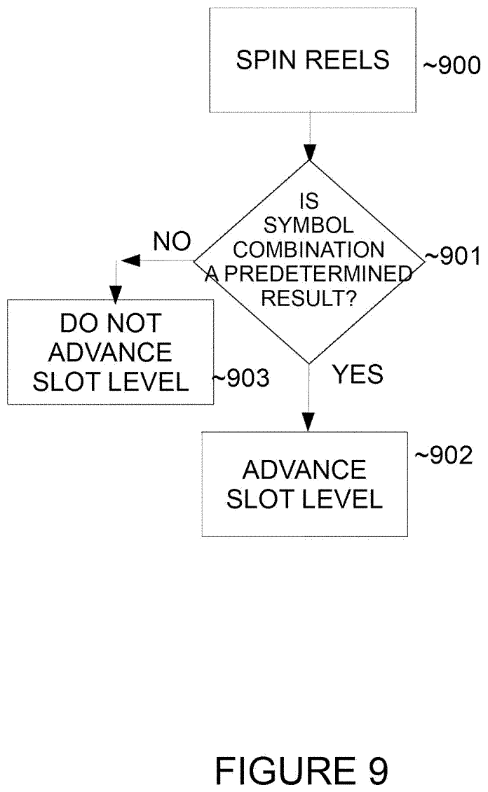

FIG. 9 is a flowchart illustrating an exemplary method of advancing a slot level, according to an embodiment. Note that typically, the game would start (initialize) with the slot level being at level number 1. Note that FIG. 9 is implemented in the context of the rest of the game as described herein.

In operation 900, the reels on the (virtual) slot machine would spin. This can be done as described herein and known in the art.

From operation 900, the method proceeds to operation 901, which determines whether the resultant symbol combination from the spin in operation 900 is a predetermined combination which triggers an advance in the slot level. If the resultant symbol combination is not a predetermined combination which triggers an advance in the slot level, then the method proceeds to operation 903 which does not advance a slot level.

If in operation 901, the resultant symbol combination is a predetermined symbol combination, then the method proceeds to operation 902, which advances a slot level (increases the slot level by 1).

Different slot levels can have different symbols, paytables, features, probabilities, etc.

Note that leaderboards also have levels. Once a player has earned at least a predetermined amount from a respective leaderboard level, the player would advance to the next leaderboard level. Typically, when a player first begins playing the game (e.g., when the player registers), the player would start on leaderboard level 1. Note that each leaderboard is not limited to only one particular slot level, but players from various different slot levels can all be on the same leaderboard.

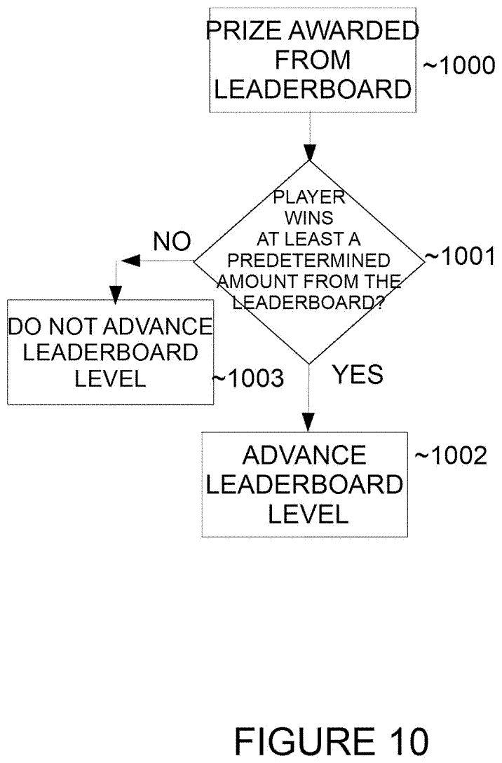

FIG. 10 is a flowchart illustrating an exemplary method of advancing a leaderboard level, according to an embodiment.

In operation 1000, a cash award is awarded when a leaderboard expires (i.e., the leaderboard's time is up and the winning players on the leaderboard are awarded their prizes).

From operation 1000, the method proceeds to operation 1001, which determines whether the player won at least a predetermined amount (e.g., $25 or other amount) from the leaderboard from operation 1000. If the player did not win at least the predetermined amount, then the method proceeds to operation 1003 and the player does not advance leaderboard levels (i.e., the player's leaderboard level stays where it is).

If in operation 1001, the player has won at least a predetermined amount from the leaderboard (in operation 1000), then the method proceeds to operation 1002. In operation 1002, the player advances to the next leaderboard level (typically the leaderboard level is increased by one).

The higher the leaderboard level, typically the higher the prizes that are awarded. For example, Table II below shows three different leaderboard levels and their respective prizes. Note that “first prize” means the highest score on the leaderboard when the leaderboard expires, “second prize” corresponds to the second-highest score when the leaderboard expires, and “third prize” corresponds to the third-highest score when the leaderboard expires. In this example, fourth place (and further on) do not get prizes.

TABLE II

| Leaderboard level | first prize | second prize | third prize |
|---|---|---|---|
| 1 | $100 | $50 | $25 |
| 2 | $150 | $100 | $100 |
| 3 | $250 | $150 | $50 |

In an embodiment, the bonus round can be limited so that a player cannot trigger the bonus round twice while the player is at the same slot level. In one embodiment, the determination in operation 1001 operates on a one-time basis, that is, the player must win at least the predetermined amount on a single award (i.e., at one time) in order to advance to operation 1002. In an alternative embodiment, the determination in operation 1001 is performed on a cumulative basis (the sum of all awards on the same leaderboard level must be at least the predetermined amount). For example, if the predetermined amount is $10, then the player can win awards of $5, $3, and $2 on the same leaderboard level and qualify for an advance (proved to operation 1002) of the leaderboard level (because a cumulation of $5, $3, and $2 is $10). Note that in the “cumulative” embodiment, if the player still won at least the predetermined amount at one time then this would still be considered adequate to advance the leaderboard level (proceed to operation 1002).

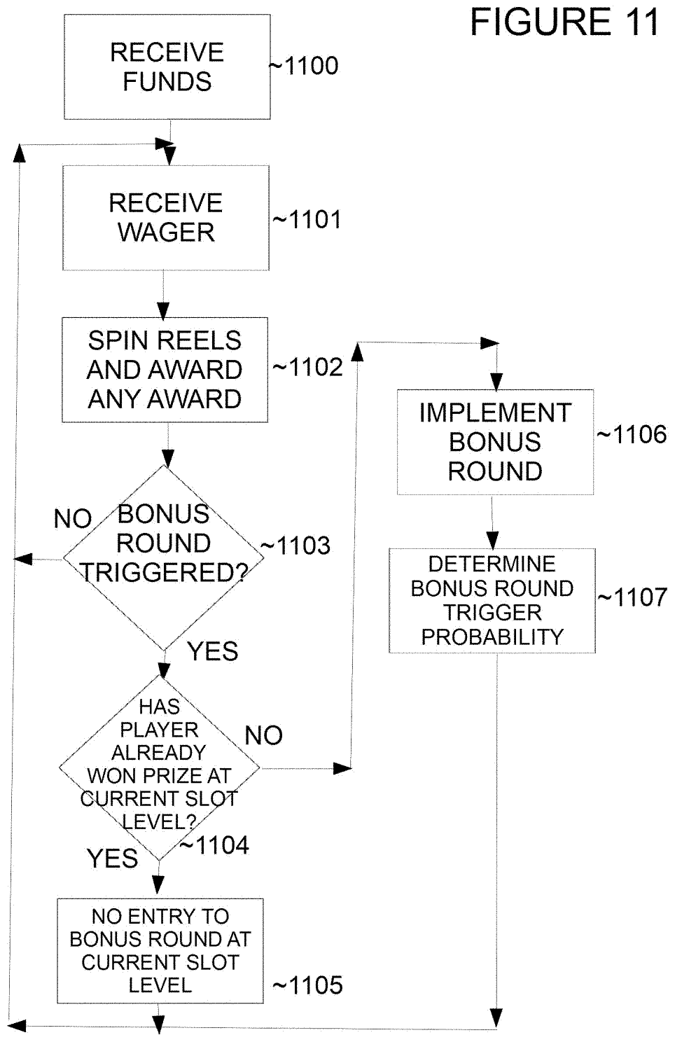

FIG. 11 is a flowchart illustrating an exemplary method of playing a game in which triggering the bonus round is limited, according to an embodiment.

Operations 1100, 1101, 1102, 1103, 1106, 1107 are implemented the same as operations 400, 401, 402, 403, 404, 405, respectively. In operation 1104, it is determined whether the player had already won a prize at the current slot level. If so, then the method proceeds to operation 1105, which prevents entry to the bonus round at the current slot level. If not, then the method proceeds to operation 1106, which implements the bonus round.

In operation 1101, non-monetary credits are wagered to play the slot game. in operation 1102, any award awarded is also awarded in non-monetary credits. The only way to win a valuable prize (e.g., cash award) would be to trigger the bonus round, obtain a score which is then placed on the leaderboard, and when the leaderboard expires if the score is ranked high enough (against the other players on the same leaderboard) then the player wins a cash award.

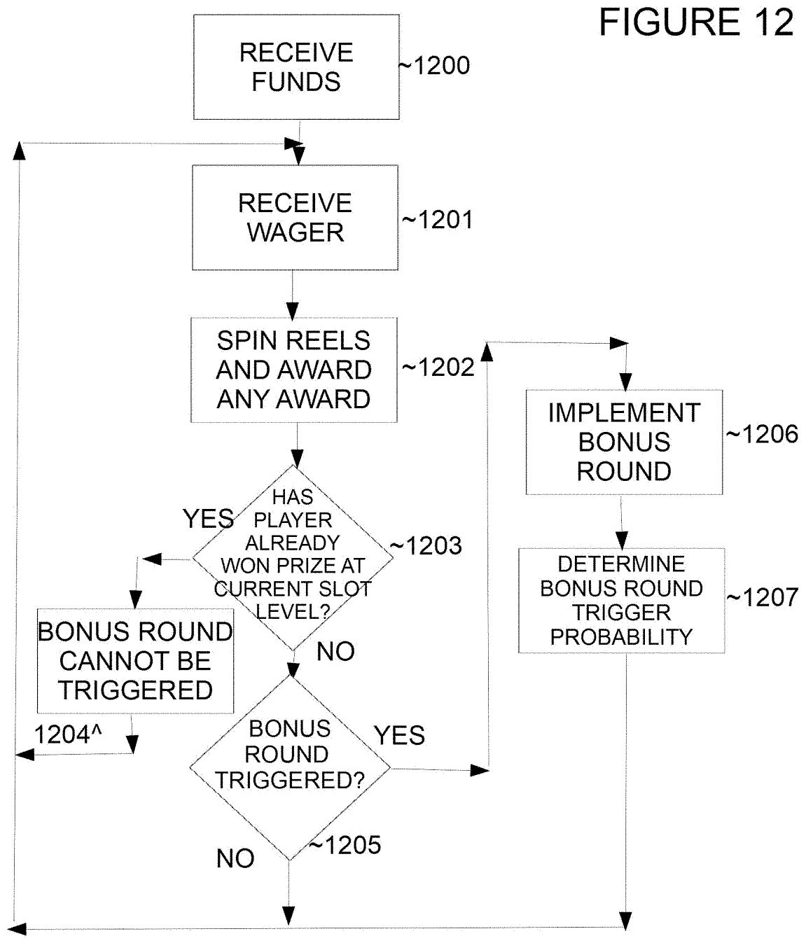

FIG. 12 is a flowchart illustrating a further exemplary method of playing a game in which triggering the bonus round is limited, according to an embodiment. FIG. 12 is similar to FIG. 11 (and each individual operation is carried out the same way), but in FIG. 11, after the bonus round would have been triggered, the bonus round is then stopped from being implemented if the player has already won a prize at the current slot level, while in FIG. 12, if the player had already won a prize at the current slot level then no determination is made whether or not to trigger the bonus round. As such, either method could be used to restrict access to the bonus round when the player has already won a prize at the same slot level.

In a further embodiment, the player can reach the leaderboard a second time only after a predetermined period has elapsed. For example, if the player has reached the leaderboard once, then the player cannot reach the leaderboard again until the next day (e.g., midnight on the following day or any other period of time).

In an embodiment, once the player has won a cash award (from being on the leaderboard), the probability of triggering the bonus round again (e.g., operations 405, 509, 1107, 1207) while the player remains on the same slot level (the slot level which triggered the bonus round in which the player won the cash award) would be adjusted (and typically harder (or impossible) for the player to trigger the bonus round again while on the same slot level). For example, the probability on slot level 1 of triggering the bonus round is 1/100 (a pure random determination using a random number generator), and after the player wins a cash award on the leaderboard the probability of triggering the bonus round then drops down to 1/150 (and so on). Once the player advances to the next slot level (e.g., slot level 2), then the probability of triggering the bonus round then is adjusted according to predetermined rules. Table III below illustrates an example of how bonus round probability triggers are adjusted.

TABLE III

| Slot | p(tb) 0 | p(tb) 1 | p(tb) 2 (or more) |
|---|---|---|---|
| level | cash awards | cash award | cash awards |
| 1 | 1/100 | 1/150 | 0 |
| 2 | 1/75 | 1/100 | 0 |
| 3 | 1/100 | 1/200 | 0 |

In Table III, p(tb) represents the probability of triggering the bonus round. So, for example, at slot level 1, if the player has not won a cash award at slot level 1 then the probability of triggering the bonus round is 1/100. Once the player wins one cash award at slot level 1, the probability of triggering the bonus round decreases to 1/150 (harder to trigger). When the player remains at slot level 1 and triggers a second cash award, then the probability of triggering the bonus round decreases to 0 (the bonus round cannot be triggered). Subsequently, the probability of triggering the bonus round can remain at 0 regardless of how many more cash awards the player wins (at slot level 1). If the player is at slot level 1, and advances the slot level (to slot level 2), then the probability of triggering the bonus round would be 1/75 (it does not matter how many cash awards the player won while on slot level 1). While winning a cash awards is described as triggering an adjustment of the probability of triggering the bonus round, instead of cash awards it could be any type of award (e.g., a particular award, any award, etc.)

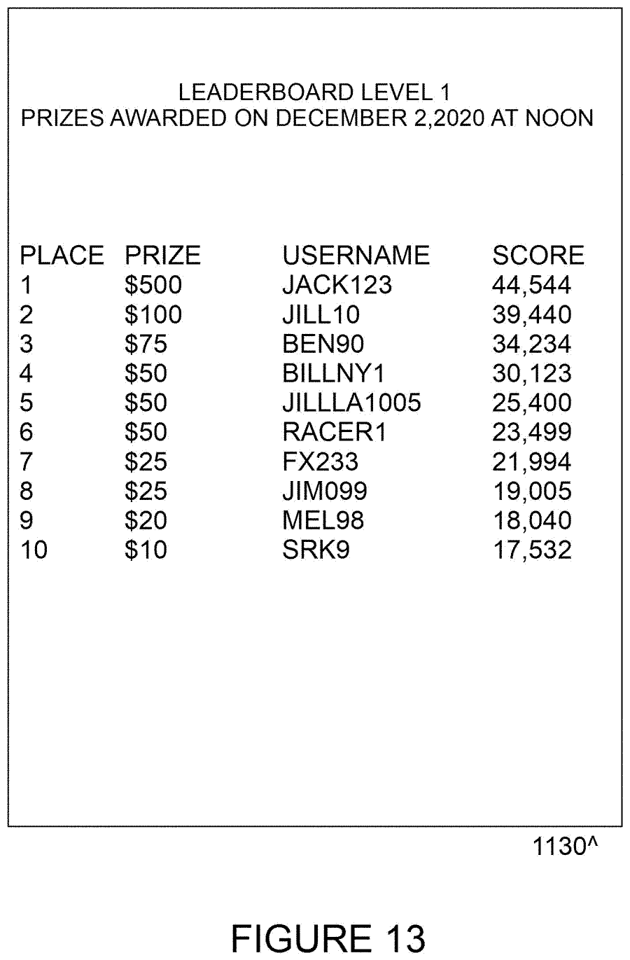

FIG. 13 is a drawing of a leaderboard display, according to an embodiment. At any time, any player can view any of the leaderboards, or at least any leaderboard where the player is listed on.

Shown is the level one leaderboard. The players listed on this leaderboard can be on any level of the slot game (e.g., mixed slot levels) but are all on leaderboard level 1. The players are all ranked according to their score in the bonus round. When the leaderboard expires, the top 10 players (highest 10 scores) will all win their respective awards (this could also be the top 100 players (highest 100 scores), top 1000 players (highest 1000 scores), etc. Players who do not have a top 10 highest score are not listed on the leaderboard.

FIG. 14 is a flowchart illustrating an exemplary method of utilizing a leaderboard to award prizes.

In operation 1400, a new leaderboard for a particular leaderboard level (e.g., leaderboard level 1, leaderboard level 2, etc.) is initiated (no players are listed on it yet).

From operation 1400, the method proceeds to operation 1401, which maintains the leaderboard. As players enter the bonus round, their scores are posted to the leaderboard (unless their score does not rank high enough to win a prize). Players who are on leaderboard level 1 will utilize leaderboard level 1, players who are on leaderboard level 2 will utilize leaderboard level 2, etc.

From operation 1401, the method proceeds to operation 1402, which determines whether the leaderboard time has expired. Each leaderboard will have a time it will expire (e.g., every 24 hours, every week, etc.) If the leaderboard does not expire, then the method returns to operation 1401 which continues to maintain the leaderboard.

If in operation 1402, the leaderboard time has expired, then the method proceeds to operation 1403, which awards prizes (note that nouns “prize” and “award” are used synonymously herein) to the winners on the leaderboard. The method can then proceed to operation 1400 which can initiate a new leaderboard for the same level.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All features described herein (including all documents incorporated by reference) can be combined with one another without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An apparatus, comprising:
at least one processor connected to the internet, the at least one processor connected to at least one computer readable storage storing computer readable instructions, the computer readable instructions programmed to cause the at least one processor to perform:
enable a player to play a main game using non-monetary credits wherein a result of the main game is determined randomly without regard to player skill;
determine whether the result triggers a skill bonus round, and if the player triggers the skill bonus round then implementing the skill bonus round which is different from the main game and involves skill, wherein in the skill bonus round the player earns a player's score based on the player's performance, and placing the player's score on a leaderboard which has an expiration time;
upon expiration of the leaderboard, awarding awards to winning players, the winning players having highest scores on the leaderboard out of all of the players on the leaderboard.

2. The apparatus as recited in claim 1, wherein the computer readable instructions are further programmed such that the awards are a cash award.

3. The apparatus as recited in claim 1, wherein the computer readable instructions are further programmed such that the player would not be able to play the main game unless the player has remaining non-monetary credits.

4. The apparatus as recited in claim 1, wherein the computer readable instructions are further programmed such that during play of the main game, when the result is a predetermined combination the player advances a main game level.

5. The apparatus as recited in claim 1, wherein the computer readable instructions are further programmed such that when the player wins at least a predetermined award on the leaderboard, the player advances a leaderboard level, wherein the predetermined award is required to be won at one time.

6. The apparatus as recited in claim 1, wherein the computer readable instructions are further programmed such that when the player wins at least a predetermined award on the leaderboard, the player advances a leaderboard level, wherein the predetermined award is won on a cumulative basis.

7. The apparatus as recited in claim 1, wherein the computer readable instructions are further programmed such that a level A leaderboard has an average award amount of X dollars and a level B leaderboard has an average award amount of Z dollars, wherein B>A and Z>X.

8. The apparatus as recited in claim 1, wherein the computer readable instructions are further programmed such that the skill bonus round cannot be triggered if the player has already won an award at a current slot level of the player.

9. The apparatus as recited in claim 1, wherein the computer readable instructions are further programmed such that if the player already has a prior score on the leaderboard before the player's score is earned, then the player's score is not placed on the leaderboard unless the player's score is higher than the prior score upon which the prior score is replaced by the player's score.

10. The apparatus as recited in claim 1, wherein the computer readable instructions are further programmed such that when the player wins a valuable award from being on the leaderboard, a probability of triggering the skill bonus round on a successive play of the main game decreases.

11. The apparatus as recited in claim 10, wherein the computer readable instructions are further programmed such that the valuable award is a cash amount or gift card.

12. A method, comprising:
at least one processor executing computer readable instructions which causes the following operations:
enabling a player to play a main game using non-monetary credits wherein a result of the main game is determined randomly without regard to player skill;
triggering a skill bonus round based on the result;
implementing the skill bonus round which is different from the main game and involves skill, wherein in the skill bonus round the player earns a player's score based on the player's performance, and placing the player's score on a leaderboard which has an expiration time;
waiting until expiration of the leaderboard and then awarding awards to winning players, the winning players having highest scores on the leaderboard out of all of the players on the leaderboard.

12. The method as recited in claim 11, wherein the awards are a cash award.

14. The method as recited in claim 12, further comprising preventing the player from playing the main game unless the player has remaining non-monetary credits.

15. The method as recited in claim 12, further comprising advancing a main game level of the player resulting from the result being a predetermined combination.

16. The method as recited in claim 12, further comprising advancing a leaderboard level of the player resulting from the player winning at least a predetermined award on the leaderboard, wherein the predetermined award is won at one time.

17. The method as recited in claim 12, further comprising advancing a leaderboard level of the player resulting from the player winning at least a predetermined award on the leaderboard, wherein the predetermined award is won on a cumulative basis.

18. The method as recited in claim 12, further providing that: a level A leaderboard has an average award amount of X dollars and a level B leaderboard has an average award amount of Z dollars, wherein B>A and Z>X.

19. The method as recited in claim 12, further comprising preventing the skill bonus round from being triggered after the player has already won an award at a current slot level of the player.

20. The method as recited in claim 12, further providing that: if the player already has a prior score on the leaderboard before the player's score is earned, then the player's score is not placed on the leaderboard unless the player's score is higher than the prior score upon which the prior score is replaced by the player's score.

21. The method as recited in claim 12, further comprising, the player wins a valuable award from being on the leaderboard, and decreasing a probability of triggering the skill bonus round on a successive play of the main game.

22. The method as recited in claim 21, further providing that the valuable award is a cash amount or gift card.
